(19) United States
(12) Patent Application Publication
(10) Pub. No.: US 2008/0248910 A1
(43) Pub. Date: Oct. 9, 2008

(54) Infinitely Variable Ratio Gearbox

(76) Inventor: Roger James Turvey, Kent (GB)

Correspondence Address: LUEDEKA, NEELY & GRAHAM, P.C., P O BOX 1871, KNOXVILLE, TN, 37901, US

(21) Appl. No.: 11/813,174

(22) PCT Filed: Jan. 4, 2006
(86) PCT No.: PCT/GB06/00011

§ 371 Date: Jan. 3, 2008

(30) Foreign Application Priority Data
Jan. 4, 2005 (GB) 0500026.0

(51) Int. Cl. F16H 3/72; F16H 3/56

(52) U.S. Cl. 475/91

(57) ABSTRACT

A stepless variable ratio gear train (201) comprising first and second stage gear trains (1), (101) with controllable variable velocity ratios between their inputs and outputs, wherein the velocity of the output of the first stage gear train (1) relative to the input of the first stage gear train (1) is decreased when a relatively high torque is applied to the gear train (201), and is increased when a relatively low torque is applied to the gear train (201). The gear train (201) further comprising means to control the velocity ratio of the first stage gear train (1) comprising a brake (301) that produces a relatively high braking force when a relatively low torque is applied to it to produce a low velocity ratio in the first stage and second stage gear trains (1), (101) and a relatively low braking force when a relatively high torque is applied to it to produce a high velocity ratio in the first stage and second stage gear trains (1), (101).

The present invention relates to an Infinitely Variable Ratio Gearbox (IVRG). In particular, the present invention relates to the use of such a IVRG in a motor vehicle.

Gearboxes used in motor vehicles, and other machines, essentially provide a number of different ratios between a power unit, for example an internal combustion engine, and driving means, for example, the driven road wheels of a car in order to make the most effective possible use of the engine's torque. The band of engine speeds at which an engine is producing a high level of torque is relatively narrow in comparison to the complete range of engine speeds, i.e. the range up to the permissible maximum speed of the engine. The use of gear ratios enables the engine to be maintained in this narrow band whilst driving an output, for example the driving wheels of a car, at a wide range of speeds.

In the case of a car, to overcome the rolling resistance, internal losses and air resistance that are the characteristics of that car, and also to overcome any undulations in terrain, an engine must be able to rotate at a sufficient speed in order to develop an adequate torque that can be supplied to the driven road wheels of the car in order to overcome the resistances.

A constant torque, if it could be applied throughout an infinitely variable range of engine speeds, would provide a constant acceleration up to the point where air resistance, internal losses and rolling resistance would equal the power output and stabilise the velocity at a peak figure.

However, an engine cannot produce a constant torque output over an infinite range of engine speeds. An engine has an optimum rotational speed where it is producing maximum torque. If the engine speed is increased or decreased the torque produced by the engine will decrease. Therefore a gearbox is necessary to keep the engine speed within a desirable range where the engine can develop adequate torque output to overcome the resistances.

As the rotational speed of the driven road wheels of a car rises, a higher gear ratio becomes necessary to preserve the engine speed within the desirable range, as the speed of the vehicle decreases a lower gear ratio becomes necessary to preserve the engine speed within the desirable range.

Similarly, if the load placed on the engine increases, for example if the car is driving up an incline, a lower gear ratio may become necessary to preserve the engine speed within the desirable range.

Normally speaking, five gear ratios are found to be adequate for most cars although some high performance cars may have many more.

The necessity to change gear ratios has a number of implications:
1. The engine is only briefly at peak output during acceleration and therefore the acceleration of the vehicle is not optimised.
2. Related limitations apply to fuel economy since optimum power is related to fuel usage and the energy output produced from this.
3. Changing of gears involves a power cessation during which acceleration is negative.

It follows that increases in fuel efficiency and/or increased maximum acceleration of a vehicle might be achieved by increasing the number of gear ratios if these increases were not reduced by the inefficiencies resulting from the need to change gear frequently.

Automatic gearboxes apparently overcome some of these problems by optimising the gear change pattern and employing some form of torque conversion which, effectively, slips the clutch during changes. However, in practice, these devices are only automated manual gearboxes and still rely on changing ratios to achieve their results, thus wasting power and achieving less than optimum results.

Therefore, the requirement is for a gearbox that is able to provide a continuous ratio variation that will adjust between engine speed and the speed of a driving means, for example the rotational speed of a set of driven road wheels on a car, thus supplying exactly the right gear ratio at any given instant of acceleration, deceleration or steady velocity and keeping the engine at the optimum rotational speed.

The requirement is known to automotive engineers the world over and some solutions have been designed, varying from the fluid transmission of 1960's US gas-guzzlers to the DAF “rubber band” solution. None of these were particularly satisfactory since the inherent inefficiency or the unreliability of the methodology obviated the potential advantages.

A constant mesh, infinitely variable ratio gearbox would confer benefits in efficiency of fuel consumption, better performance and less wear and tear and is therefore very desirable, provided that mechanical efficiency can be maintained through the transmission and provided that the costs of manufacture are not inordinate.

Accordingly, the present invention provides a stepless variable ratio gear train comprising at least one first stage gear train with a controllable variable velocity ratio between an input and at least one output, determined by the torque applied to the gear train, and at least one second stage gear train with a variable velocity ratio between at least one input and an output, determined by the velocity ratio of the first stage gear train, wherein the velocity of the output of the first stage gear train relative to the input of the first stage gear train is decreased when a relatively high torque is applied to the gear train, and the velocity of the output of the first stage gear train relative to the input of the first stage gear train is increased when a relatively low torque is applied to the gear train, the gear train further comprising means to control the velocity ratio of the first stage gear train comprising at least one brake that produces a relatively high braking force when a relatively low torque is applied to it to produce a low velocity ratio in the first stage and second stage gear trains and a relatively low braking force when a relatively high torque is applied to it to produce a high velocity ratio in the first stage and second stage gear trains.

In a preferred embodiment of the present invention, the at least one brake produces a braking force that is inversely proportional to the torque that is applied to the gear train.

Preferably, the at least one brake comprises means for producing a variable braking force that varies in response to changes in the torque applied to the gear train.

In a preferred embodiment of the present invention, the brake comprises a rotor rotating within a stator, the rotor comprising at least one vane that is moveable relative to the rotor and fixed to rotate with the rotor, and the stator comprising a casing for containing a viscous fluid, the vicous fluid providing a resistive force against rotation with the rotor of the at least one vane, in order to resist rotation of the rotor.

Preferably, the at least one vane is movable relative to the rotor to change the projected area of the vane in the viscous fluid and hence the magnitude of the resistive force applied to the vane by the viscous fluid, in order to change the magnitude of the force resisting rotation of the rotor.

Preferably, the at least one vane is provided with biasing means such that when the torque applied to the gear train is at a minimum the vane is positioned such that the resistive force applied to the vane by the viscous fluid is at a maximum.

Preferably, the at least one vane is movable into a position such that when the torque applied to the gear train is at a maximum the vane is positioned such that the resistive force applied to the vane by the viscous fluid is at a minimum.

In a preferred embodiment of the present invention the brake comprises a casing that is fixed relative to the gear train and a cylindrical rotor that rotates within the casing and which is attached to the gear train, the rotor further comprising two elongate vanes, each vane having a hollow semi-circular cross-section, each vane extending substantially along the whole length of the casing and each vane fixed to the rotor diametrically opposite each other and so that it is rotatable about an axis parallel to the axis of the rotor, the vanes being biased by a resilient element into a position in which their free edges are furthest from the rotor and the vanes being movable against the force provided by the biasing element into a position in which their free edges are closest to the rotor. It is envisaged that the brake may take any other suitable form, e.g. it may be an electromagnetic brake.

Preferably, the brake further comprises means to transmit rotation between the rotor and a component of the first stage gear train.

In the preferred embodiment the first stage gear train and the second stage gear train are epicyclic gear trains. However, it is envisaged that the first and second stage gear trains may also be any other suitable constant mesh transmission arrangement, or equivalent, that is able to provide a variable ratio between an input and an output.

Preferably, the at least one first stage gear train has an input, a first output and a second output, and the at least one second stage gear train has a first input, a second input and an output, wherein the first output of the first stage gear train is connected to the second input of the second stage gear train and the second output of the first stage is connected to the first input of the second stage gear train.

Preferably, each of at least one first stage and second stage epicyclic gear trains comprise a sun gear, at least one planet gear, a planet gear carrier and a ring gear, each of which is rotatable.

In the preferred embodiment, in the first stage gear train the input is the planet carrier the first output is the sun gear and the second output is the ring gear and for the second stage gear train the first input is the sun gear, the second input is the ring gear and the output is the planet carrier.

In the preferred embodiment the means to prevent counter-rotation of the gear train is a one-way clutch attached to the sun gear of the first stage gear train, and/or the ring gear of the second stage gear train.

The at least one brake may be applied to at least one ring gear. Preferably, the at least one brake is applied to the ring gear of the first stage gear train.

In a preferred embodiment, the present invention further comprises a gear that is attached to the rotor and arranged to be in constant mesh with the ring gear of the first stage gear train so that the resistive force applied by the viscous fluid is transferred to that ring gear.

It is envisaged that the stepless variable ratio gear train may be used in a vehicle, wherein the output of the prime mover of the vehicle is applied to the input of the first stage gear train and the output of the second stage gear train is applied to at least one driven road wheel of the vehicle.

In a preferred embodiment the present invention further comprises means to prevent the second stage gear train from rotating in a different direction to the first stage gear train.

In a preferred embodiment of the present invention preferably the stepless variable ratio gear train comprises means to prevent the planet carrier of the second stage gear train from rotating in a different direction to the planet carrier of the first stage gear train.

Preferably, the means to prevent the planet carrier of the second stage gear train from rotating in a different direction to the planet carrier of the first stage gear train is a uni-directional rotational device.

Preferably, the uni-directional device is a one-way clutch attached to the external ring gear of the second stage gear train and the sun gear of the first stage gear train.

A preferred embodiment of the present invention will now be described with reference to the accompanying figures in which:

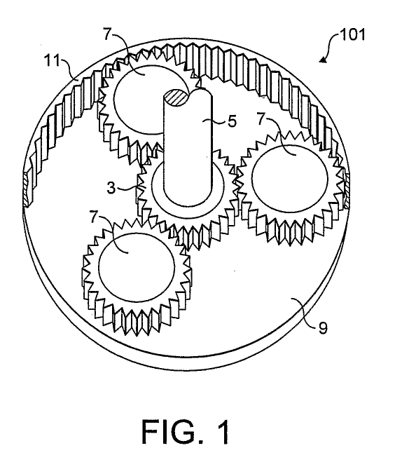

FIG. 1 is a perspective view of an epicyclic sun and planet gear train in combination with a planet carrier and an external ring gear according to the present invention;

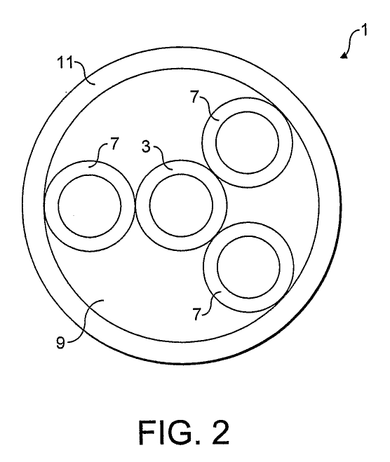

FIG. 2 is a schematic front elevation of the epicyclic gear train of FIG. 1;

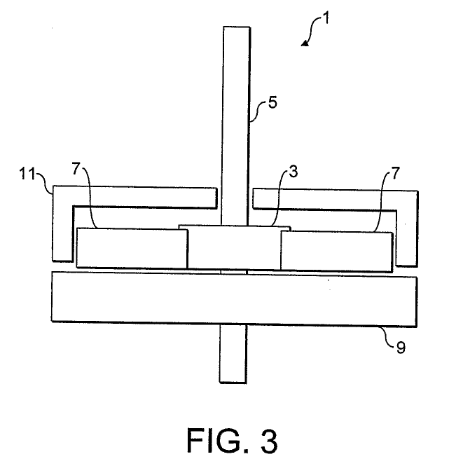

FIG. 3 is a schematic side elevation of the epicyclic gear train of FIG. 1;

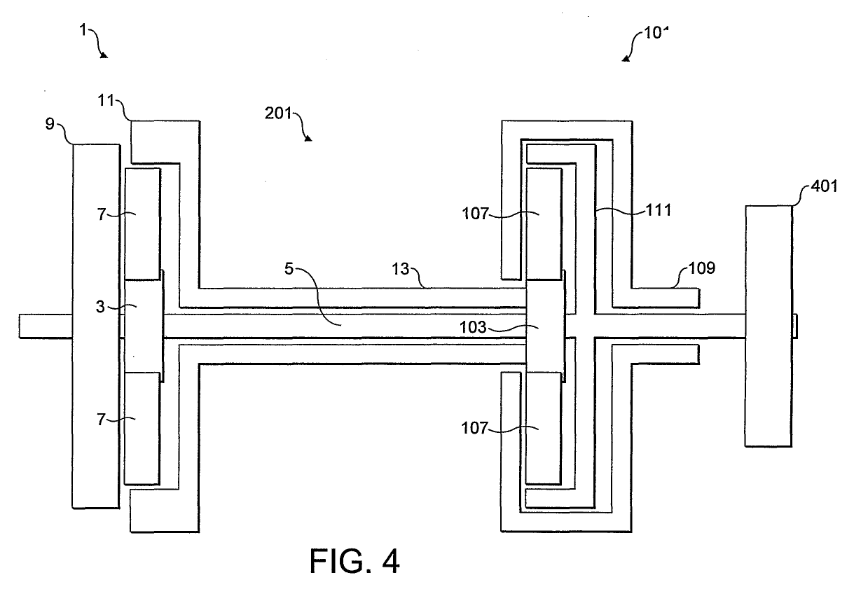

FIG. 4 is a schematic cross-sectional side elevation of a first stage epicyclic gear train and second stage epicyclic gear train according to FIG. 1 connected together;

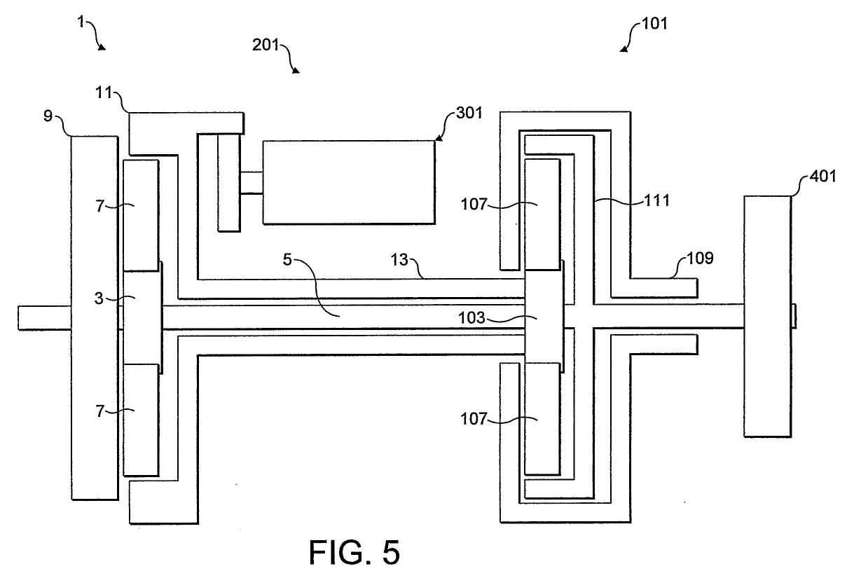

FIG. 5 is a schematic cross-sectional side elevation of FIG. 4 with a brake applied to the external ring gear of the first stage epicyclic gear train;

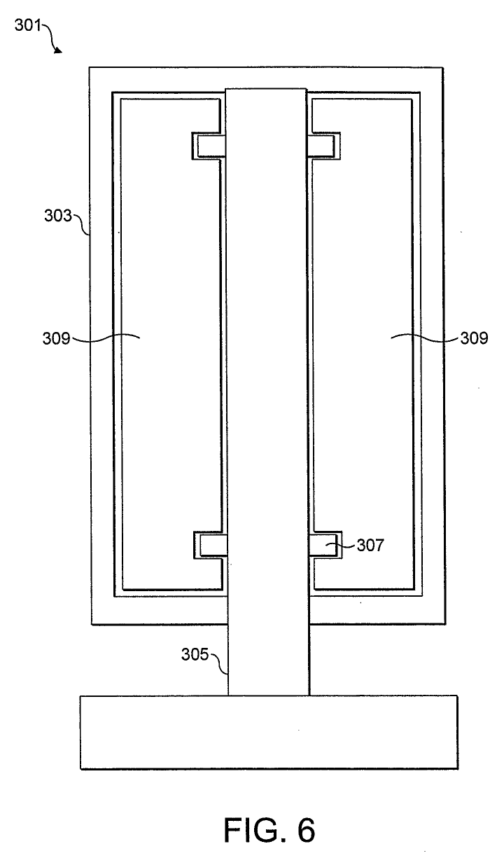

FIG. 6 is a schematic cross-sectional side elevation of the brake shown in FIG. 5 with vanes extended;

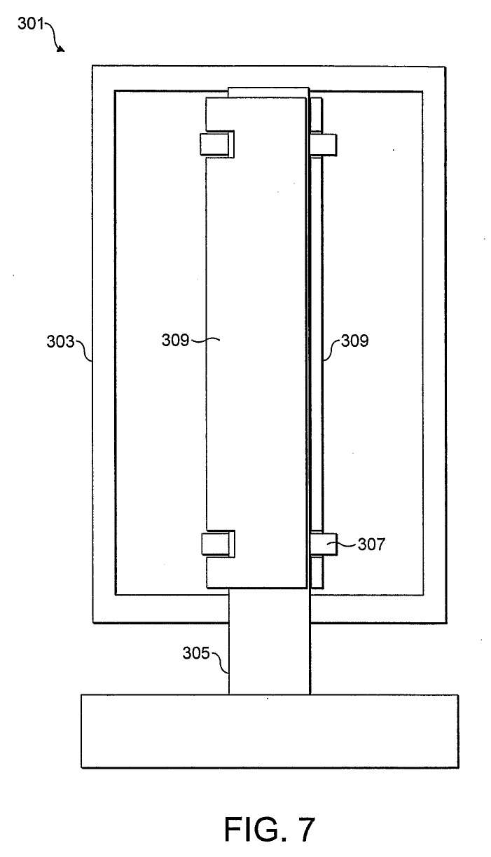

FIG. 7 is the schematic cross-sectional side elevation of FIG. 6 with vanes contracted;

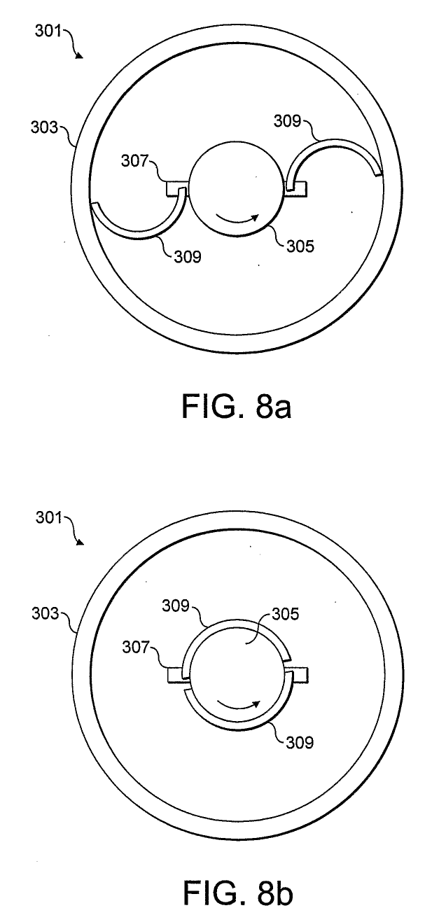

FIG. 8a is a schematic cross-sectional front elevation of the brake with vanes in the extended position; and

FIG. 8b is a schematic cross-sectional front elevation of the brake with vanesin the contracted position.

A preferred embodiment of the present invention in which the Infinitely Variable Ratio Gearbox (IVRG) is used in the transmission of a car is described below.

The basic premise of the IVRG is that the gears contained in the IVRG will be in constant mesh with each other and that it will not be necessary to change between a set of discrete gear ratios but it will be possible to utilise an infinitely variable series of ratios which will be dictated by the engine output and the load that must be overcome, i.e. the rolling resistance, internal losses and air resistance that are characteristic of the car in which the IVRG is used.

To understand the principle it is only necessary to look at the epicyclic gear train that is commonly used in the differential gearboxes of vehicles to supply two variable outputs from one power input, dictated by road resistance. However, the differential described here is different in that its moving parts all rotate about parallel axes, gaining benefits of reduced stresses and friction from that. It also supplies two differing outputs rather than the two equal outputs in conventional differentials.

An example of such an epicyclic gear train is shown in FIG. 1. This epicyclic gear train forms the first stage of the IVRG according to the present invention.

The first stage epicyclic gear train 1 comprises a sun gear 3 fixedly attached to and rotating with a shaft 5. The sun gear 3 is in mesh with three planet gears 7. The planet gears 7 are supported on stub axles (not shown) fixed to a planet carrier 9. The planet gears 7 mesh with an external ring gear 11 (shown partially cut away in FIG. 1). If none of the components of the gear train are restrained from rotating the sun gear 3, the planet carrier 9 and the external ring gear 11 are free to rotate about the axis of shaft 5. The planet gears 7 are free to rotate about the stub axles.

The first stage epicyclic gear train 1 has one input and two outputs. The planet carrier 7 is the input, the shaft 5 and the external ring gear 11 are the two outputs.

The planet carrier 7 is attached, via a clutch, to the output of the engine of the car (not shown).

The shaft 5 and the external ring gear 11 are attached to the inputs of the second stage epicyclic gear train 101.

In operation the planet carrier 9 rotates in the direction of the engine rotation carrying the planet gears 7 about the rotational axis of the sun gear 3.

The relative diameters of the components in this example are:

| | |
|---|---|
| Sun gear (3) | 1 |
| Planet gears (7) | 1 |
| External ring gear (11) | 3 [internal diameter] |

The first stage epicyclic gear train I is shown schematically in FIGS. 2 and 3.

The first stage epicyclic gear train 1 can provide two fixed ratios. The first ratio is obtained by preventing rotation of the shaft 5. The external ring gear 11 rotates one and one third revolutions for every revolution of the planet carrier 9. The second ratio is obtained by preventing rotation of the external ring gear 11. The shaft 5 rotates four revolutions for every revolution of the planet carrier 9.

These fixed ratios are determined by the relative diameters of the components of the epicyclic gear train 1. The ratios can be varied by changing the relative diameters of the components of the epicyclic gear train 1.

The fixed ratios represent the lowest and highest gear ratios that can be obtained from the first stage epicyclic gear train 1. However, by controlling the rotation of the components of the epicyclic gear train I it is possible to obtain any gear ratio between the lowest and highest fixed ratios.

The power applied to the input of the epicyclic gear train 1 will take the path of least resistance to the output of the epicyclic gear train 1 unless it is forced to do otherwise. The lowest fixed gear ratio represents the path of least resistance.

If the shaft 5 and the external ring gear 11 are allowed to rotate freely the power applied to the epicyclic gear train 1 will take the path of least resistance through the lowest gear ratio and the external ring gear 11 will rotate whilst the sun gear 3 will remain stationary.

If the external ring gear 11 is prevented from rotating then, because the planet carrier 9 and hence the planet gears 7 are rotating the sun gear 3 must rotate. The power applied to the epicyclic gear train 1 will thus be forced to take the path of greatest resistance through the highest gear ratio.

If a restraining force is applied to the external ring gear 11 such that it can rotate, but at a reduced speed, both the sun gear 3 and the external ring gear 11 will rotate. Thus, a gear ratio in between the lowest and highest gear ratios will be obtained.

Therefore, by controlling the speed of rotation of the external ring gear 11 it is possible to obtain an infinitely variable range of gear ratios between the highest and lowest fixed ratios.

In order to utilise this gear arrangement in the IVRG it is necessary to combine the first and second outputs from the first stage epicyclic gear train 1 in order to provide a single output. This is achieved by combining the first stage epicyclic gear train 1 with a second stage epicyclic gear train 101.

The second stage epicyclic gear train 101 contains the same components as the first stage epicyclic gear train 1. However, the second stage epicyclic gear train 101 is connected to the first stage epicyclic gear train 1 in such a way that the lowest gear chain of the first stage epicyclic gear train 1 is connected to the highest gear chain of the second stage epicyclic gear train 101. If the second stage epicyclic gear train 101 were symetrically connected to the first, i.e. lowest gear chain to lowest gear train and highest gear train to highest gear train, it would not provide anything other than a complex shaft with, effectively, one ratio.

The gear train 201 formed by the combination of the first and second stage epicyclic gear trains 1,101 is shown in FIG. 4. The two outputs of the first stage epicyclic gear train 1 become the two inputs of the second stage epicyclic gear train 101. The second stage epicyclic gear train 101 has a single output.

The external ring gear 11 is extended to a shaft 13 which connects to the sun gear 103 of the second stage epicyclic gear train 101. The sun gear 103 is the same diameter as the sun gear 3. The shaft 5 connected to the sun gear 3 is extended to the external ring gear 111 of the second stage epicyclic gear train 101. The planet carrier 109 of the second stage epicyclic gear train 101 folds over the external ring gear 111 and supports the three planet gears 107 which mesh with the external ring gear 111 and the sun gear 103 and rotate about the rotational axis of the sun gear 103. The planet carrier 109 is the output from the second stage epicyclic gear train 101. When used in a car the planet carrier 109 supplies the output for the driven road wheels.

The combination of the first and second stage epicyclic gear trains 1,101 gives the gear train 201 an overall fixed ratio of 9:1. When the lowest gear chain is selected, i.e. by preventing rotation of the shaft 5, and hence the first stage sun gear 3, the output of the gear train 201, the output planet carrier 109, is rotating at ⅓ the speed of the input planet carrier 9. When the highest gear chain is selected, i.e. by preventing rotation of the first stage external ring gear 11, the output of the gear train 201, the output planet carrier 109, is rotating at 3 times the speed of the input planet carrier 9. The gear train 201 provides the potential for a continuous ratio variation between these two fixed ratios, without having to take any of the gears out of mesh.

The gear train 201 described above is a mechanism for providing continuous ratio variation. However, to use the gear train 201 in the IVRG to be used in the transmission of a vehicle or a machine it is necessary to provide a control mechanism in order that the correct gear ratio is selected according to the circumstances. This control mechanism must determine the correct gear ratio by relating the load experienced by the gear train 201 to the engine power that can be supplied to the gear train 201 at any point of motion/acceleration of the vehicle or machine. Without some form of control, all the power supplied to the gear train 201 would channel down the path of least resistance, i.e. through the lowest gear ratio. This lowest gear ratio is provided by the external ring gear 11 connected to the sun gear 103 by shaft 113. To control the gear train 201 a restraining force must be applied to the external ring gear 11, as described above.

The restraining force could be supplied, as previously noted, by some variety of frictional device or brake but this would be inefficient, wasting power in the form of heat. In the preferred embodiment of the present invention the restraining force is provided by a hydraulic damper arrangement 301 as described below in reference to FIGS. 5 to 8.

It should be noted that the operation of this damper mechanism 301 is non-typical. The normal function of a damper is to provide progressively more resistance to movement as force is applied to it. The function of this damper mechanism 301 is non-typical in that it is required to initially offer high resistance to motion which rapidly decreases when the resistance is overcome. Then, as less force is applied to it, the damper mechanism 301 re-establishes its high resistance. The reverse of the normal damper characteristics. The description of how the damper mechanism 301 operates will make this design objective clearer.

The damper mechanism 301 is connected to the external ring gear 11 of the first stage epicyclic gear train 1. The external ring gear 11 is provided with an extension which has a set of internal gear teeth which mesh with the damper mechanism 301, as shown schematically in FIG. 5. The following paragraphs describe the damper mechanism 301.

The damper mechanism 301 is an oil-filled cylinder 303 which is fixed to the static part of the vehicle. A shaft 305, driven by the extended external ring gear 11 runs the complete length of this cylinder 303. Attached to the shaft 305, by lugs 307, are two vanes 309 that are spring loaded and fill most of the cross-section of the cylinder 303, thereby providing a high resistance to motion. These vanes 305 are almost complete semi-circles and, under high pressure, will fold round the shaft 305, thus providing a negligible resistance to motion. This is illustrated in FIG. 7 and in FIGS. 8a and 8b.

FIG. 8a shows the damper mechanism 301 in cross-section with the vanes 309 fully extended, held in position by the springs (not shown) and offering a high resistance to motion. This represents the situation when the power being applied to the gear train 201 is insufficient to overcome the spring-loading of the vanes 309.

FIG. 8b shows the damper mechanism 303 in cross-section with the vanes 309 collapsed around the shaft 305. This represents the situation when the power being applied to the gear train 201 is sufficient to overcome the spring-loading of the vanes 309. In this position, the vanes 309 offer negligible resistance to rotation of the shaft 305.

In the context of the complete IVRG, a description of what happens when a car pulls away from rest, should make this clear.

Power generated by the engine is applied to the input shaft of the IVRG. This input shaft is connected to the planet carrier 9 of the first stage epicyclic gear train 1. Without the damper mechanism 301, this power would channel through the gear chain with the lowest gear ratio, i.e. the external ring gear 11 and the sun gear 103, because this gear chain offers the least resistance, to the exclusion of the gear chain with the highest gear ratio, i.e. the sun gear 3 and the external ring gear 111, because this gear chain offers the greatest resistance. However, the extended vanes 309 of the damper mechanism 301 resist rotation of the external ring gear 11 and hence resist the rotation of the gear chain with the lower gear ratio.

If sufficient power is applied to the IVRG, as is required when a vehicle is required to pull away from rest, the vanes 309 will collapse under the applied force and the resistance to rotation of the shaft 305 will drop to a negligible figure. The first stage external ring gear 11 is then able to rotate and the power is channeled through the lowest gear ratio. In the example described in reference to this preferred embodiment of the present invention the lowest gear ratio is 1:⅓, i.e. the output of the IVRG is rotating at one third the speed of the input to the IVRG. The input to the IVRG is connected to the engine. This enables the rotational speed of the engine to be greater and hence the output of the engine is higher which allows the vehicle to pull away smoothly.

It is usual once a vehicle has moved away from rest for it to be accelerated to a chosen speed and then for the acceleration to be halted so that the vehicle remains at this cruising speed. For optimum performance it will be necessary to change gear during acceleration of the vehicle and once the vehicle has reached its cruising speed. The operation of the IVRG during these phases is explained below.

As the vehicle accelerates the speed of the driven road wheels will increase and consequently the speed of the engine will increase. If this increase in engine speed results in the engine output decreasing then it is advantageous to select a higher gear ratio to maintain the engine at its peak output. The IVRG facilitates this. When the power applied to the IVRG is reduced the vanes 309 in the damper mechanism 309 will start to move away from the shaft 305 under the influence of the spring force. This results in braking of the first stage external ring gear 11 and the consequent selection of a higher gear ratio, as described above. The selection of a higher gear ratio enables the engine speed to be reduced so that the engine is once more operating at peak output. This gear selection procedure occurs continuously throughout the acceleration phase.

At the start of the acceleration phase the lowest gear ratio of the IVRG will be selected. As the vehicle accelerates, it will reach a plateau in terms of power when the pressure on the lower gear chain will reduce. This phenomenon is readily understood by anyone who has ridden a bicycle in a low gear and accelerated as hard as possible. If no gear change takes place, although the rider is still exerting maximum effort, the chain becomes slack because the relative torque has not increased—since it is a function of speed and power—and the bicycle stops accelerating. In the IVRG, the same is true and the lower torque will be insufficient to overcome the spring loading force of the vanes 309 and hence will be insufficient to keep the vanes 309 in the damper mechanism 301 depressed round the shaft 305. The vanes 309 will progressively move outward as the torque applied to the IVRG decreases, providing a resistance against the rotation of the external ring gear 11. Rotation of the lowest gear chain is then inhibited and torque is transferred to the higher gear chain. In practice, as the gear train 201 is a differential arrangement, the damper mechanism 301 will balance the power being supplied between the highest and lowest gear chains, progressively increasing the balance towards the highest gear ratio as the velocity of the vehicle increases. This is exactly the behaviour required to keep the ratio between engine speed and driven road wheel speed correct for any part of the desired range of driven road wheel speeds.

Once the car reaches its cruising speed the power output of the engine is reduced in order to halt acceleration. The power that the engine must now supply need only match the rolling resistance, internal losses and air resistance of the car. The vanes 309 of the damper mechanism 301 will fold out, further restrain rotation of the external ring gear 11 and select a gear ratio appropriate to the engine speed and the speed of the driven road wheels of the car.

This operation of the IVRG will also occur in the situation where a vehicle accelerates from a cruising speed to a higher cruising speed. Acceleration from a cruising speed warrants an increase in output from the engine. This increase in output causes the vanes 307 on the damper 301 to fold inwards and hence reduce the restraining force on the external ring gear 11 allowing a lower gear to be selected.

This operation of the IVRG will also occur if the load applied to the IVRG increases, for example by virtue of an incline. The damper mechanism 301 senses the torque being applied by the engine to the driven road wheels and not just the rotational velocity of the driven road wheels. The IVRG is designed to balance engine output power against the load applied to the IVRG for any set of circumstances, to do this without changing gear and as a smooth transition rather than in incremental, quantum jumps.

When the IVRG is used in a car it is also necessary to provide the IVRG with a further component to facilitate its operation. It is a characteristic of the IVRG that when the driven road wheels, and hence the IVRG output, are prevented from rotating and the vehicle's engine and hence the IVRG input are rotated the gear train 201 will rotate in a direction counter to that required for movement of the vehicle in a forwards direction. This has the consequence that even when the driven road wheels and hence the IVRG output are allowed to rotate the gear train 201 will not rotate in the direction pertaining to forwards movement of the vehicle because the path of least resistance through the gear train 201 is still in the direction of counter rotation. The component described below prevents this counter-rotation of the gear train 201 and hence enables the vehicle to be pulled away from rest.

In the situation where the first stage planet carrier 9 is being rotated by the engine but the second stage planet carrier 109 is prevented from rotating, as a result of the driven road wheels to which it is attached being braked, the gear train 201 will counter-rotate. This counter-rotation represents the path of least resistance and hence the path down which the power supplied by the engine to the gear chain 201 will channel. The result of this counter-rotation is that the driven road wheels will not be rotated by the engine when the braking force is removed because the counter-rotation of the gear train will still represent the path of least resistance.

In the preferred embodiment of the present invention the means to prevent counter-rotation is in the form of a one-way clutch 401, as shown in FIG. 4.

The one-way clutch 401 is attached to the end of the shaft 5 that connects the first stage sun gear 3 to the second stage external ring gear 111. This shaft 5 passes through the second stage planet carrier 109 which is the output from the IVRG. The operation of the IVRG incorporating this one-way clutch is described below.

When the vehicle is stationary with the driven road wheels braked the second stage planet carrier 109 is prevented from rotating. In the preferred embodiment of the present invention the first stage planet carrier 9 rotates clockwise (n.b. all directions of rotation are viewed from the output side of the IVRG looking towards the input side). The one-way clutch 401 permits rotation of the second stage external ring gear 111 and the first stage sun gear 3 only in a clockwise direction.

Clockwise rotation of the second stage external ring gear 111 would rotate the second stage planet gears 107 in a clockwise direction and the second stage sun gear 103 in an anti-clockwise direction. The second stage sun gear 103 is attached to the first stage external ring gear 111 and therefore the first stage external ring gear 11 would rotate in an anti-clockwise direction. However, rotation of the first stage external ring gear 11 is only possible in a clockwise direction.

It is also not possible for the first stage external ring gear 11 to rotate in the opposite direction to the first stage planet carrier 9. Consequently, the gear train 201 is unable to rotate. It is not possible for the first stage external ring gear 11 to remain stationary relative to the first stage planet carrier 9 such that it rotates clockwise in an absolute sense. The first stage external ring gear 11 is attached to the second stage sun gear 103. As mentioned above the second stage sun gear 103 must rotate in an anti-clockwise direction because it is driven in that direction by the second stage planet gears 107 which are driven by the second stage external ring gear 111 which cannot rotate in a clockwise direction because it is prevented from doing so by the one-way clutch 401.

It is envisaged that the control means to prevent counter-rotation of the gear train 201 may take any suitable form. The counter-rotation may be prevented by means other than a one-way clutch 401 and the counter-rotation means may be fitted elsewhere in the gear train 201, provided that the same effect is achieved.

Because the one-way clutch 401 prevents rotation of the gear train 201 when the output planet carrier 109 is prevented from rotating, when the IVRG is used in a vehicle with a conventional internal combustion engine arrangement it is necessary to provide means for uncoupling the IVRG from the vehicle's engine, so that the engine may idle when the vehicle is stationary. It is envisaged that a clutch may be provided between the engine output and the IVRG input. The clutch may be of any suitable type, for example it may be a centrifugal clutch or a diaphragm clutch.

However, if the IVRG is used in a vehicle powered by an electric motor or by a non-conventional internal combustion engine arrangement, that is intended to be stopped when the vehicle comes to rest and started again when the vehicle moves off, or a hybrid combination of the two it may not be necessary to provide means to decouple the IVRG from the power unit (s).

1. A stepless variable ratio gear train, comprising:
a first stage gear train with a controllable variable velocity ratio between an input and at least one output, determined by the torque applied to the gear train,
a second stage gear train with a variable velocity ratio between at least one input and an output, determined by the velocity ratio of the first stage gear train, and
braking means arranged to control the velocity ratio of the first stage gear train,
wherein the braking means is arranged to produce a relatively high braking force when a relatively low torque is applied to it to produce a higher relative velocity of the second stage gear train output relative to the first stage gear train input, and a relatively low braking force when a relatively high torque is applied to it to produce a lower relative velocity of the second stage gear train output relative to the first stage gear train input.

2. A stepless variable ratio gear train as claimed in claim 1, wherein braking means produces a braking force that is inversely proportional to the torque that is applied to the gear train.

3. A stepless variable ratio gear train as claimed in claim 1, wherein the braking means is arranged to produce a variable braking force that varies in response to changes in the torque applied to the gear train.

4. A stepless variable ratio gear train as claimed in claim 1, wherein the braking means comprises a rotor arranged to rotate within a stator, the rotor comprising at least one vane that is moveable relative to the rotor and fixed to rotate with the rotor, and the stator comprising a casing for containing a viscous fluid, the viscous fluid providing a resistive force against rotation of the at least one vane and the rotor.

5. A stepless variable ratio gear train as claimed in claim 4, wherein the at least one vane is movable relative to the rotor to change the projected area of the vane in the viscous fluid and hence the magnitude of the resistive force applied to the vane by the viscous fluid.

6. A stepless variable ratio gear train as claimed in claim 4, wherein the at least one vane is provided with biasing means such that when the torque applied to the gear train is at a minimum the vane is positioned such that the resistive force applied to the vane by the viscous fluid is at a maximum.

7. A stepless variable ratio gear train as claimed in claim 4, wherein the at least one vane is movable into a position such that when the torque applied to the gear train is at a maximum the vane is positioned such that the resistive force applied to the vane by the viscous fluid is at a minimum.

8. A stepless variable ratio gear train as claimed in claim 1, wherein the braking means comprises a casing that is fixed and a cylindrical rotor that is rotatable within the casing and which is attached to the gear train, the rotor further comprising two elongate vanes, each vane having an arcuate cross-section, each vane extending substantially along the whole length of the casing and each vane fixed to the rotor diametrically opposite the other and so that it is rotatable about an axis parallel to the axis of the rotor, each vane being biased by a resilient element into a position in which its free edge is furthest from the rotor and each vane being movable against the force provided by the resilient element into a position in which its free edge is closest to the rotor.

9. A stepless variable ratio gear train as claimed in claim 4, wherein the braking means further comprises means to transmit rotation between the rotor and a component of the first stage gear train.

10. A stepless variable ratio gear train as claimed in claim 9, wherein the braking means further comprises means to transmit rotation between the rotor and a component of the first stage gear train.

11. A stepless variable ratio gear train as claimed in claim 1, wherein the first stage gear train and the second stage gear train are epicyclic gear trains.

12. A stepless variable ratio gear train as claimed in claim 1, wherein the at least one first stage gear train has an input, a first output and a second output, and the second stage gear train has a first input, a second input and an output, wherein the first output of the first stage gear train is connected to the second input of the second stage gear train and the second output of the first stage gear train is connected to the first input of the second stage gear train.

13. A stepless variable ratio gear train as claimed in Claim 12, wherein each of the first stage and second stage epicyclic gear trains comprise a sun gear, at least one planet gear, a planet gear carrier and a ring gear, each of which is rotatable.

14. A stepless variable ratio gear train as claimed in claim 13, wherein for the first stage gear train the input is the planet carrier, the first output is the sun gear and the second output is the ring gear and for the second stage gear train the first input is the sun gear, the second input is the ring gear and the output is the planet carrier.

14. canceled

15. A stepless variable ratio gear train as claimed in claim 13 wherein the braking means is applied to at least one ring gear.

16. A stepless variable ratio gear train as claimed in claim 13, wherein the braking means is applied to the first stage ring gear of the first stage gear train.

17. A stepless variable ratio gear train as claimed in claim 13, further comprising a gear that is attached to the braking means and arranged to be in constant mesh with the ring gear of the first stage gear train so that the resistive force applied by the viscous fluid is transferred to that ring gear.

18. A stepless variable ratio gear train as claimed in claim 1, for use in a vehicle, wherein the output of the prime mover of the vehicle is applied to the input of the first stage gear train and the output of the second stage gear train is applied to at least one driven road wheel of the vehicle.

19. A stepless variable ratio gear train as claimed in claim 1, further comprising means to prevent the second stage gear train from rotating in a different direction to the first stage gear train.

20. A stepless variable ratio gear train as claimed in claim 14, further comprising means to prevent the planet carrier of the second stage gear train from rotating in a different direction to the planet carrier of the first stage gear train .

21. A stepless variable ratio gear train as claimed in claim 20 wherein the means to prevent the planet carrier of the second stage gear train from rotating in a different direction to the planet carrier of the first stage gear train is a uni-directional rotational device.

22. A stepless variable ratio gear train as claimed in claim 21 wherein the unidirectional device is a one-way clutch attached to the ring gear of the second stage gear train and the sun gear of the first stage gear train.

23. canceled
